(19) United States
(12) Patent Application Publication
(10) Pub. No.: US 2023/0378989 A1
(43) Pub. Date: Nov. 23, 2023

(54) SYSTEMS AND METHODS FOR WIRELESS COMMUNICATIONS IN HEAD-MOUNTED DEVICES

(71) Applicant: Microsoft Technology Licensing, LLC, Redmond, WA (US)

(72) Inventors: Yijun ZHOU, Mountain View, CA (US); Heesuk CHUNG, San Jose, CA (US); Qingxiang LI, Cupertino, CA (US); Abrian Jacob MIHALKO, Collinsville, CT (US); Mohit NARANG, Cupertino, CA (US); Rubén CABALLERO, San Jose, CA (US); Robert Joseph HILL, Medford, OR (US)

(21) Appl. No.: 17/751,036

(22) Filed: May 23, 2022

(51) Int. Cl. H04B 1/3827; G02B 27/01; H01Q 1/24

(52) U.S. Cl. CPC H04B 1/385; G02B 27/017; H01Q 1/241; H04B 2001/3866

(57) ABSTRACT

An electronic device has a frame configured to be worn on a user's head, where the frame includes a body and a temple coupled to the body. The body is configured to support a lens. The electronic device includes a processor in the frame and an RF antenna positioned in the body and in data communication with the processor.

### BACKGROUND

### Background and Relevant Art

Smartglasses and other head-mounted devices (HMDs) position electronic components close to the user's head during use. Some electronic components can produce radio frequency (RF) radiation. The amount of exposure a user can have to RF radiation is, in some areas of the world, regulated to limit any potential adverse effects to the user.

### BRIEF SUMMARY

In some embodiments, an electronic device has a frame configured to be worn on a user's head, where the frame includes a body and a temple coupled to the body. The body is configured to support a lens. The electronic device includes a processor in the frame and an RF antenna positioned in the body and in data communication with the processor.

In some embodiments, an electronic device includes a frame configured to be worn on a user's head where the frame includes a body configured to support a lens, a first temple coupled to the body, and a second temple coupled to the body. The electronic device further includes a processor in the frame, a first RF antenna positioned in the body and in data communication with the processor, and a second RF antenna positioned in the first temple or second temple and in data communication with the processor.

In some embodiments, a method of communicating data in an HMD includes providing an HMD configured to be worn on a user's head, where the HMD includes a first RF antenna positioned in a body of the HMD and a second RF antenna positioned in a temple of the HMD, receiving an incoming transmission with the second antenna, and transmitting an outgoing transmission with the first antenna.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a perspective view of a head-mounted device (HMD), according to at least one embodiment of the present disclosure;

FIG. 2 is a schematic representation of some electronic components of an HMD, according to at least one embodiment of the present disclosure;

FIG. 3 is a perspective view of a head-mounted device (HMD) with three antenna elements, according to at least one embodiment of the present disclosure;

FIG. 4 is chart illustrating different antenna frequencies, according to at least one embodiment of the present disclosure;

FIG. 5 is a perspective view of a head-mounted device (HMD) with different antenna elements in the lower rims, according to at least one embodiment of the present disclosure;

FIG. 6 is a graph illustrating radio frequency (RF) efficiency of a loop antenna, according to at least one embodiment of the present disclosure;

FIG. 7 is a graph illustrating RF efficiency of a monopole antenna, according to at least one embodiment of the present disclosure; and

FIG. 8 is a flowchart illustrating a method of wireless communication, according to at least one embodiment of the present disclosure.

### DETAILED DESCRIPTION

The present disclosure relates generally to systems and methods for wireless communication in an electronic device. More particularly, some embodiments described herein relate to wireless communication with a head-mounted device (HMD). In some embodiments, systems and methods described herein can improve transmission power and/or reduce electromagnetic radiation exposure for a user.

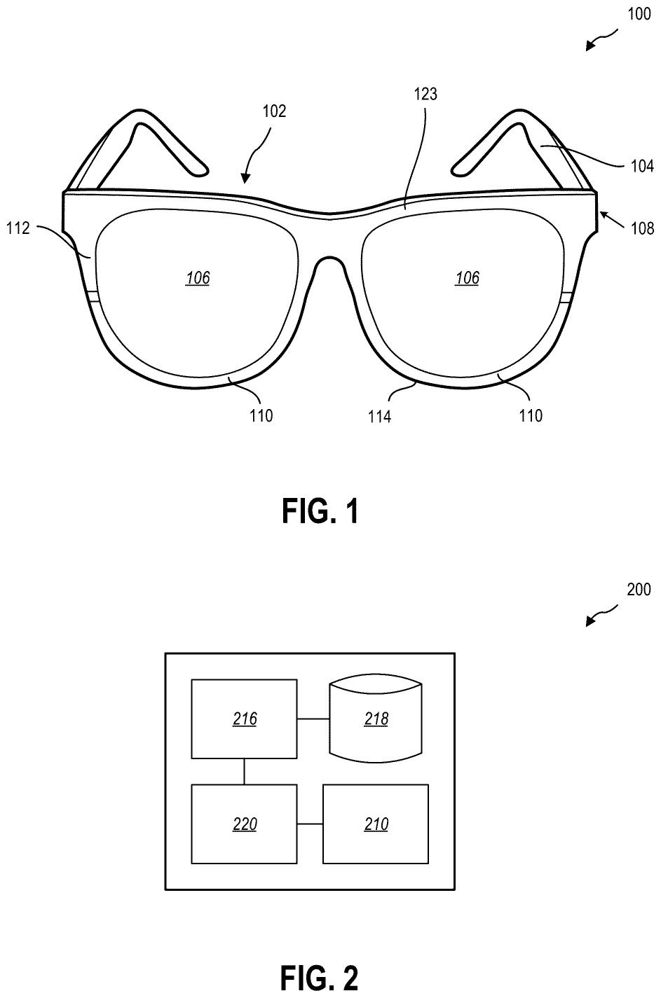

FIG. 1 is front view of an electronic device 100. In some embodiments, the electronic device 100 is a wearable electronic device 100 that is configured to be worn on the user's head. For example, the electronic device 100 may be an HMD that includes a body 102 and one or more temples 104 that collectively form a frame of the electronic device 100. The body 102 supports and/or is configured to support one or more lenses 106 in the body 102 of the electronic device 100. In some embodiments, the body 102 includes a single lens that is positioned in front of both of the user's eyes. In some embodiments, the body 102 includes two lenses 106 supported by the body 102, with each lens 106 positioned in the body 102 to be positioned in front of each of a user's eyes. In at least one example, the electronic device 100 is smartglasses that approximate the conventional shape of eyeglasses.

The temple 104 is coupled to the body 102 to support the body 102 and/or the electronic device 100 on the user's head. For example, the temple 104 is configured to rest over, behind, or around at least a portion of the user's ear to hold the electronic device 100 on the user's head. The temple 104 of the electronic device 100, when worn on the user's head, may be positioned proximate to the user's head and contacting the user's head.

In some embodiments, the body 102 and the temple(s) 104 are movably coupled to one another by a rotatable hinge 108. In some embodiments, the body 102 and the temple(s) 104 are movably coupled to one another by a flexible connection to allow rotation of the temple(s) 104 relative to the body 102. In some embodiments, the body 102 and the temple(s) 104 are rigidly connected and unable to move relative to one another.

In some embodiments, the electronic device 100 includes a plurality of electronic components positioned in the body 102 of the electronic device 100. The electronic components may include a processor, memory, communication device, battery, camera, speaker, microphone, or other electronic components that may communicate with one another. In some embodiments, the electronic device 100 includes one or more electronic component in a temple 104. The electronic component(s) housed in or supported by the body 102 may communicate with the electronic component(s) in the temple 104 through a rotatable electrical connection in the hinge 108 or a flexible electrical connection in the flexible connector.

The electronic device 100 includes a communication device that allows for wireless communication. In some embodiments, the communication device transmits or receives radio frequency (RF) signals through an antenna element 110. In some embodiments, the communication device includes a patch antenna, and transmission efficiency at various frequencies is at least partially dependent on a length of the antenna element 110. In some embodiments, the electronic device 100 includes at least part of an antenna element 110 in the body 102 of the electronic device 100. In some embodiments, the electronic device 100 includes at least part of an antenna element 110 in a temple 104. In some embodiments, the electronic device 100 includes at least part of the antenna element 110 in the hinge 108 or flexible connection.

The antenna element transmits wireless communications in the electromagnetic spectrum according to one or more communication standards. For example, between 600 Megahertz (MHz) and 960 MHz for some cellular transmissions or above 5.0 Gigahertz (GHz) for some Wi-Fi transmissions. Different nations or legal jurisdictions around the world limit the transmission power of RF antennas based on the amount of RF radiation experienced by the user of the electronic device 100. For example, the specific absorption ratio (SAR) of RF radiation by the user can depend on the frequency, power, and proximity of the transmission antenna to the user's body and, in particular, the user's head.

In some embodiments, an antenna element 100 according to the present disclosure in a body 102 of the electronic device 100 can have a transmission power of 100 milliwatts (mW) or more safely within SAR limits. In some embodiments, an antenna element 100 according to the present disclosure in a body 102 of the electronic device 100 can have a transmission power of 150 mW or more safely within SAR limits. In some embodiments, an antenna element 100 according to the present disclosure in a body 102 of the electronic device 100 can have a transmission power of 200 mW or more safely within SAR limits.

In some embodiments, positioning an antenna element in a temple of a HMD positions the source of the RF radiation proximate to or contacting the user's head. In some embodiments of electronic devices 100 according to the present disclosure, at least one antenna element 110 is positioned in the body 102 and, more particularly, in a lateral side 112 of the body 102 and/or a lower rim 114 of the body 102. For example, the lower rim 114 of the body 102 may position the antenna element 110 not contacting the user's body and spaced away from the user's body by 1-2 centimeters. In particular embodiments, an antenna element 110 is positioned in the lateral side 112 of the body 102 and/or a lower rim 114 of the body 102 and not in an upper rim 123 of the body 102 above the lens(es) 106. For example, the upper rim 123 of the body 102 may be contacting or closer to the user's forehead than the lateral side 112 of the body 102 and/or a lower rim 114 of the body 102. Positioning the antenna element 110 in the upper rim 123 of the body 102 would result in a greater RF radiation exposure to the user's head relative to the same transmission power, frequency, and duration from an antenna element 110 positioned in the lower rim 114.

The lateral side 112 of the body 102 includes a lateral-most location on the body 102 and, in some embodiments, includes the hinge 108 or flexible connection to the temple 104. In some embodiments, the lateral side 112 of the body 102 is proximate to the hinge 108 or flexible connector while not including the hinge 108 or flexible connector. In at least one embodiment, the lateral side 112 of the body 102 contacts and/or retains a lateral side of a lens 106.

The lower rim 114 of the body 102 includes a lower-most portion of the body 102, and in some embodiments, support and/or retains a lens 106. In some embodiments, the lower rim 114 of the body 102 is continuous around a lower edge of the lens 106, such as full frame eyeglasses. In other embodiments, the lower rim 114 of the body 102 contacts and supports a portion of the lens 106 and is non-continuous across the entire bottom of the lens 106, such as semi-rimless frame eyeglasses.

Positioning the antenna element 110 in the lower rim 114 of the body 102 can reduce the SAR by up to 25% relative to positioning the antenna element 110 in a temple 104 of the electronic device 100 or the upper rim 123 of the body 102 (for an equivalent transmission power and frequency).

FIG. 2 is a system diagram of electronic components housed in or supported by the body and temples (such as the body 102 and temples 104 described in relation to FIG. 1) of some embodiments of an electronic device 200. In some embodiments, the electronic device 200 includes a processor 216 that is in data communication with a hardware storage device 218 and a communication device 220. The communication device 220 is in electrical communication with and/or includes an antenna element 210.

In some embodiments, the hardware storage device(s) 218 is a non-transient storage device including any of RAM, ROM, EEPROM, magnetic disk storage or other magnetic storage devices, or any other medium which can be used to store desired program code means in the form of computer-executable instructions or data structures and which can be accessed by a general purpose or special purpose processor, such as the processor 216. In some embodiments, the hardware storage device 218 has instructions stored thereon that, when executed by the processor, cause the electronic device 200 to perform any parts of any of the methods described herein.

In some embodiments, the communication device(s) 220 is in data communication with the processor(s) 216 to allow communication with one or more external computing devices, networks, or components. In some embodiments, the communication device is a network communications device, such as Wi-Fi or cellular. In some embodiments, the communication device is a short-range wireless communication, such as a BLUETOOTH connection or a Wi-Fi-Direct connection, which allows data communication between the electronic device 200 and other electronic devices in proximity to the electronic device 200 without connection to a network adapter or access point.

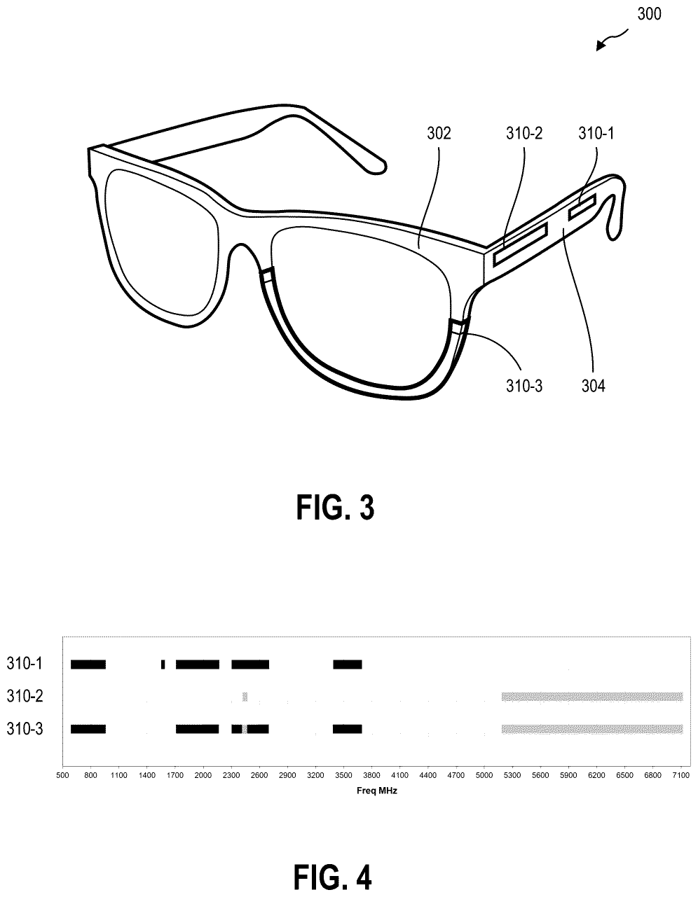

FIG. 3 is a perspective view of an embodiment of an HMD or electronic device 300 according to the present disclosure. In some embodiments, an electronic device 300 includes a plurality of antenna elements 310-1, 310-2, 310-3. For example, each of the antenna elements 310-1, 310-2, 310-3 may be in electrical communication with a different communication device (such as the communication device 220 described in relation to FIG. 2). In other examples, at least two antenna elements 310-1, 310-2, 310-3 of the plurality of antenna elements 310-1, 310-2, 310-3 are in electrical communication with a single communication device. In at least one embodiment, an electronic device 300 includes three antenna elements 310-1, 310-2, 310-3. The three antenna elements 310-1, 310-2, 310-3 may be used for different purposes depending on the position of the antenna elements 310-1, 310-2, 310-3 on the body 302 and/or temple(s) 304 (and the associated relationship to the user's head).

For example, a first antenna element 310-1 is positioned at a distal end 322 of the temple 304 away from the body 302. The position of the first antenna element 310-1 allows the first antenna element 310-1 to receive an incoming RF transmission with comparatively less interference from other electronic components that are located in the body 302 of the electronic device 300. However, the position of the first antenna element 310-1 may cause outgoing RF transmission from the first antenna element 310-1 to expose the user's head to greater RF radiation and causes more signal attenuation from the user's head than another antenna element positioned elsewhere on the electronic device 300. A second antenna element 310-2 may be positioned on/in the temple 304, and a third antenna element 310-3 may be positioned on/in the body 302. For example, a first antenna element 310-1 may be positioned in one temple 304 and a second antenna element 310-2 may be positioned in another temple 304. In another example, a first antenna element 310-1 may be positioned in a proximate portion of a temple 304 (e.g., closer to the body 302) and a second antenna element 310-2 may be positioned in a distal portion of the temple 304 (e.g., further from the body 302).

The antenna elements on the temple(s) 304 may be diversity antennas, which are primarily used for receiving RF transmissions, while the third antenna element 310-3 positioned in/on the body 302 may be the primary antenna for transmissions, allowing the electronic device 300 to transmit at a higher transmission power.

FIG. 4 is a graph of an example distribution of frequencies for each antenna element 310-1, 310-2, 310-3 described in relation to FIG. 3. In some embodiments, the antenna elements are the same and can receive or transmit at the same frequencies. In some embodiments, at least one of the antenna elements is different from another and can receive or transmit at different frequencies. For example, the first antenna element 310-1 of FIG. 4 is a diversity antenna that operates in the cellular ranges between 600 MHz and 3.7 GHz and in the global positioning system (GPS) range at approximately 1.6 GHz. The second antenna element 310-2 of FIG. 4 is a diversity antenna that operates in the Wi-Fi ranges at approximately 2.4 GHz and above 5.0 GHz. The third antenna element 310-3 of FIG. 4 is a primary antenna that operates in both the cellular and Wi-Fi ranges.

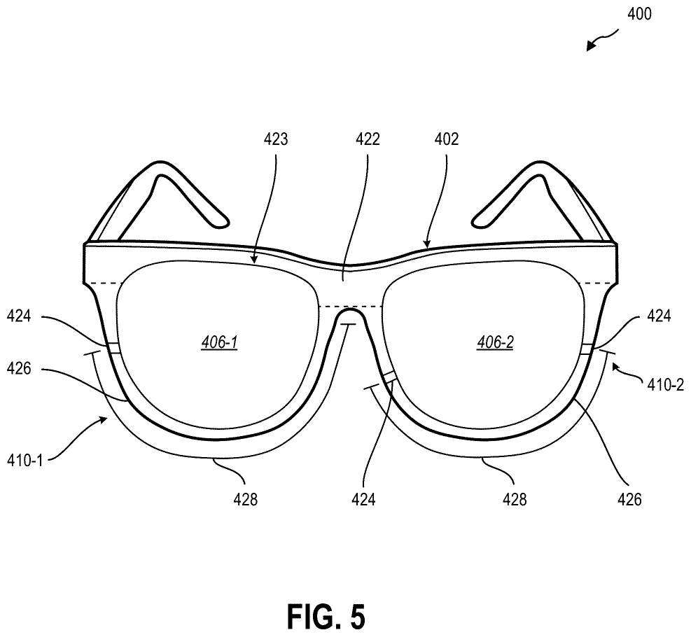

The antenna element in the body of the electronic device may be placed in different locations and/or have different configurations. For example, FIG. 5 illustrates an embodiment of an electronic device 400 with a first antenna element 410-1 on a first side of the body 402 (e.g., proximate a first lens 406-1) and a second antenna element 410-2 on a second side of the body 402 (e.g., proximate a second lens 406-2). In some embodiments, the housing or outer surface of a portion of the body 402 is conductive and the conductive material of the body 402 is part of the antenna element 410-1, 410-2. In other embodiments, the conductive material of the antenna element 410-1, 410-2 is positioned inside a nonconductive (e.g., plastic) housing of the body 402. A conductive material of the body 402 can be used for the antenna element 410-1, 410-2 to reduce mass and size of the body 402 of the electronic device 400.

In some embodiments, the first antenna element 410-1 is a loop antenna, and the second antenna element 410-2 is a monopole antenna. In some embodiments, the first antenna element 410-1 and second antenna element 410-2 are the same type of antenna element, such as both being a loop antenna or both being a monopole antenna. In some embodiments, the electronic device 400 has only one antenna element on/in the body 402, and in some embodiments, the electronic device 400 has more than two antenna elements on/in the body 402.

A loop antenna is an RF antenna that may be used for transmitting and/or receiving RF transmissions. The loop antenna consists of a loop of conductive material such as a wire or strip of metal. The spectrum of usable frequencies for a loop antenna is based at least partially on a perimeter length of the loop. In some embodiments, the first antenna element 410-1 of the electronic device 400 is a loop antenna element that includes a frame split 424 proximate an antenna feed 426. The antenna feed 426 feeds the first antenna element 410-1, which is connected to a ground element 422 of the body 402. In some embodiments, the effective antenna length 428 of a loop antenna, such as the first antenna element 410-1, is the length from the frame split 424 to the ground element 422. In some embodiments, the ground element 422 is positioned in an upper rim 423 of the body 402. In some embodiments, the upper rim 423 is coupled to the temple(s) 404 by a hinge 408. In some embodiments, the upper rim 423 is coupled to the temple(s) 404 by a flexible connection. In some embodiments, the upper rim 423 is coupled to the temple(s) 404 by a rigid connection.

A monopole antenna is an RF antenna that may be used for transmitting and/or receiving RF transmissions. The monopole antenna consists of a conductor, often mounted over a conductive surface. The driving signal from the transmitter is applied, or for receiving antennas the output signal to the receiver is taken, between the monopole and the ground plane. In some embodiments, the second antenna element 410-2 is a monopole antenna positioned between frame splits 424 in the lower rim 414 and/or lateral side 412 of the body 402. In some embodiments, the second antenna element 410-2 is a monopole antenna positioned between frame splits 424 in the lower rim 414 and/or lateral side 412 of the body 402 and not in the upper rim 423 of the body 402. In some embodiments, an antenna feed 426 is positioned proximate a frame split 424. In some embodiments, the effective antenna length 428 of a monopole antenna, such as the second antenna element 410-2, is the length of the conductive material (e.g., the second antenna element 410-2) between the two frame splits 424.

In some embodiments, the effective antenna length 428 of antenna elements 410-1, 410-2 of an electronic device 400 is at least partially based on the desired frequencies used by the electronic device 400. In some embodiments, the effective antenna length 428 is at least ½ of the minimum wavelength for loop antenna. For example, an antenna used to transmit or receive 5.0 GHz Wi-Fi signals may have an effective antenna length of at least 30 millimeters (mm). In another example, an antenna used to transmit or receive 1000 MHz low band cellular signals may have an effective antenna length of at least 15 cm.

In some embodiments, the effective antenna length 428 is at least ¼ of the minimum wavelength for monopole antenna. For example, an antenna used to transmit or receive 5.0 GHz Wi-Fi signals may have an effective antenna length of at least 15 mm. In another example, an antenna used to transmit or receive 1000 MHz low band cellular signals may have an effective antenna length of at least 7.5 cm.

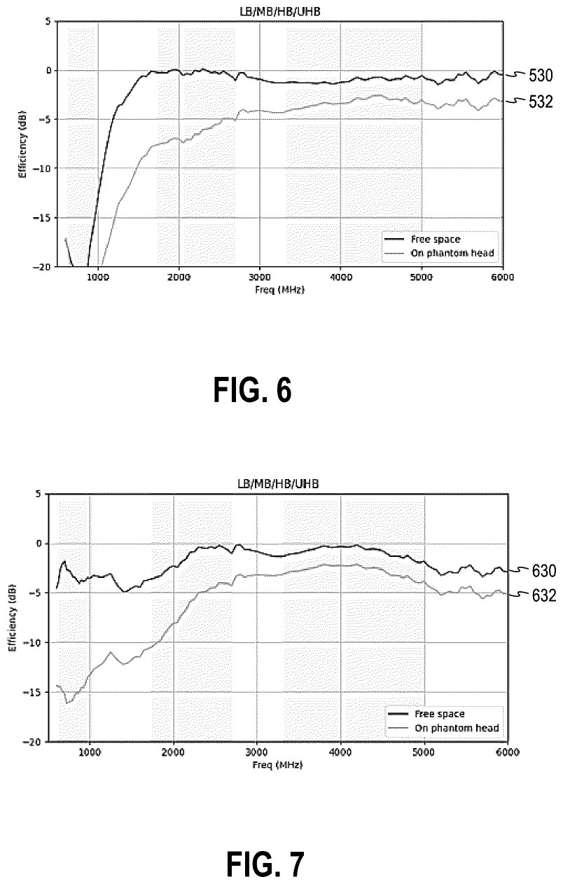

FIG. 6 and FIG. 7 illustrate measured antenna efficiencies in decibels (dB) for a loop antenna in FIG. 6 and a monopole antenna in FIG. 7. FIG. 6 is a graph that illustrates the efficiency of a loop antenna located in the lower rim of an HMD electronic device in free space 530 and when the electronic device is positioned on a phantom head 532. As described herein, the user's head can absorb a portion of the RF radiation from the antenna, and the graph of FIG. 6 illustrates the relatively larger attenuation at the lower frequencies. While the loop antenna exhibits lower efficiencies at the lower frequencies, in particular in the low band (LB) range below 1.0 GHz, the loop antenna shows sufficient performance throughout the mid-band (MB), high band (HB), and ultrahigh band (UHB).

As described in relation to FIG. 5, an antenna element for a loop antenna introduces less frame splits into the body of the electronic device. In some embodiments, less frame splits can provide a stronger body of the electronic device. For example, each frame split may introduce a weak point in the body, which compromises the strength of the body. In some embodiments, less frame splits can provide a more continuous housing for other electronic components of the electronic device. For example, some components of the electronic device may be positioned in the lower rim or lateral side of the body, and less frame splits may allow greater freedom in component positioning and/or wiring. In some embodiments, less frame splits may be more aesthetically pleasing and provide additional design opportunities.

FIG. 7 is a graph that illustrates the efficiency of a monopole antenna located in the lower rim of an HMD electronic device in free space 630 and when the electronic device is positioned on a phantom head 632. As described herein, the user's head can absorb a portion of the RF radiation from the antenna, and the graph of FIG. 6 illustrates the relatively larger attenuation at the lower frequencies. The efficiency exhibited by the monopole antenna is greater in the LB range relative to a loop antenna. However, the monopole antenna may introduce a greater number of frame splits than the loop antenna.

In some embodiments, the loop antenna and the monopole antenna are used in conjunction with one another. In some embodiments, the loop antenna and the monopole antenna are used with additional patch antennas in the electronic device. For example, the electronic device may receive transmissions with an antenna in a first location in the electronic device and transmit transmissions with a different antenna at a second location in the electronic device to limit the SAR experienced by the user. When the antenna is positioned in the body (such as a lower rim or a lateral side of the body), a higher transmission power may be used.

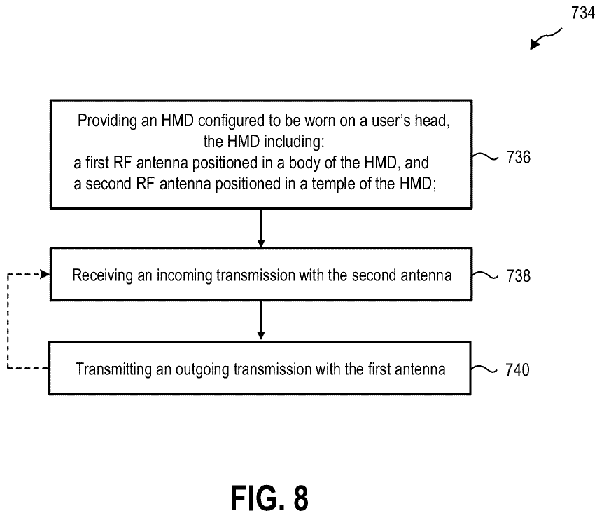

FIG. 8 is a flowchart illustrating an embodiment of a method 734 of wireless communications in an HMD. In some embodiments, the method 734 includes positioning an HMD on a user's head at 736. The HMD includes a first RF antenna positioned in or on a body of the HMD and a second RF antenna positioned in a temple of the HMD. As described herein, the first RF antenna in the body may be positioned in the lower rim of the body, in the lateral side(s) of the body, or both. The method 734 further includes receiving an incoming transmission with the second antenna at 738. After receiving the incoming transmission with the second antenna, the method 734 includes transmitting an outgoing transmission with the first antenna at 740 in response to the incoming transmission. In some embodiments, the incoming transmission and the outgoing transmission have the same frequency. In some embodiments, the incoming transmission and the outgoing transmission have a different frequency.

In at least one embodiment, an electronic device and/or method of using an electronic device according to the present disclosure allows an HMD to transmit RF signals with a greater transmission power and/or lower SAR for the user than a conventional HMD. In at least one example, a front frame antenna can transmit at least 4 times more power compared to the temple antenna at the same absorption level.

### INDUSTRIAL APPLICABILITY

The present disclosure relates generally to systems and methods for wireless communication in an electronic device. More particularly, some embodiments described herein relate to wireless communication with a head-mounted device (HMD). In some embodiments, systems and methods described herein can improve transmission power and/or reduce electromagnetic radiation exposure for a user.

In some embodiments, an electronic device is a wearable electronic device that is configured to be worn on the user's head. For example, the electronic device may be an HMD that includes a body and one or more temples that collectively form a frame of the electronic device. The body supports and/or is configured to support one or more lenses in the body of the electronic device. In some embodiments, the body includes a single lens that is positioned in front of both of the user's eyes. In some embodiments, the body includes two lenses supported by the body, with each lens positioned in the body to be positioned in front of each of a user's eyes. In at least one example, the electronic device is smartglasses that approximate the conventional shape of eyeglasses.

The temple is coupled to the body to support the body and/or the electronic device on the user's head. For example, the temple is configured to rest over, behind, or around at least a portion of the user's ear to hold the electronic device on the user's head. The temple of the electronic device, when worn on the user's head, may be positioned proximate to the user's head and contacting the user's head.

In some embodiments, the body and the temple(s) are movably coupled to one another by a rotatable hinge. In some embodiments, the body and the temple(s) are movably coupled to one another by a flexible connection to allow rotation of the temple(s) relative to the body. In some embodiments, the body and the temple(s) are rigidly connected and unable to move relative to one another.

In some embodiments, the electronic device includes a plurality of electronic components positioned in the body of the electronic device. The electronic components may include a processor, memory, communication device, battery, camera, speaker, microphone, or other electronic components that may communicate with one another. In some embodiments, the electronic device includes one or more electronic component in a temple. The electronic component(s) housed in or supported by the body may communicate with the electronic component(s) in the temple through a rotatable electrical connection in the hinge or a flexible electrical connection in the flexible connector.

The electronic device includes a communication device that allows for wireless communication. In some embodiments, the communication device transmits or receives radio frequency (RF) signals through an antenna element. In some embodiments, the communication device includes a patch antenna and transmission efficiency at various frequencies is at least partially dependent on a length of the antenna element. In some embodiments, the electronic device includes at least part of an antenna element in the body of the electronic device. In some embodiments, the electronic device includes at least part of an antenna element in a temple. In some embodiments, the electronic device includes at least part of the antenna element in the hinge or flexible connection.

The antenna element transmits wireless communications in the electromagnetic spectrum according to one or more communication standards. For example, between 600 Megahertz (MHz) and 960 MHz for some cellular transmissions or above 5.0 Gigahertz (GHz) for some Wi-Fi transmissions. Different nations or legal jurisdictions around the world limit the transmission power of RF antennas based on the amount of RF radiation experienced by the user of the electronic device. For example, the specific absorption ratio (SAR) of RF radiation by the user can depend on the frequency, power, and proximity of the transmission antenna to the user's body and, in particular, the user's head.

In some embodiments, an antenna element according to the present disclosure in a body of the electronic device can have a transmission power of 100 mW or more safely within SAR limits. In some embodiments, an antenna element according to the present disclosure in a body of the electronic device can have a transmission power of 150 mW or more safely within SAR limits. In some embodiments, an antenna element according to the present disclosure in a body of the electronic device can have a transmission power of 200 mW or more safely within SAR limits.

In some embodiments, positioning an antenna element in a temple of a HMD positions the source of the RF radiation proximate to or contacting the user's head. In some embodiments of electronic devices according to the present disclosure, at least one antenna element is positioned in the body and, more particularly, in a lateral side of the body and/or a lower rim of the body. For example, the lower rim of the body may position the antenna element not contacting the user's body and spaced away from the user's body by 1 to 2 centimeters. In particular embodiments, an antenna element is positioned in the lateral side of the body and/or a lower rim of the body and not in an upper rim of the body above the lens(es). For example, the upper rim of the body may be contacting or closer to the user's forehead than the lateral side of the body and/or a lower rim of the body. Positioning the antenna element in the upper rim of the body would result in a greater RF radiation exposure to the user's head relative to the same transmission power, frequency, and duration from an antenna element positioned in the lower rim.

The lateral side of the body includes a lateral-most location on the body and, in some embodiments, includes the hinge or flexible connection to the temple. In some embodiments, the lateral side of the body is proximate to the hinge or flexible connector while not including the hinge or flexible connector. In at least one embodiment, the lateral side of the body contacts and/or retains a lateral side of a lens.

The lower rim of the body includes a lower-most portion of the body, and in some embodiments, support and/or retains a lens. In some embodiments, the lower rim of the body is continuous around a lower edge of the lens, such as full frame eyeglasses. In other embodiments, the lower rim of the body contacts and supports a portion of the lens and is non-continuous across the entire bottom of the lens, such as semi-rimless frame eyeglasses.

Positioning the antenna element in the lower rim of the body can reduce the SAR by up to 25% relative to positioning the antenna element in a temple and/or the upper rim of the body of the electronic device (for an equivalent transmission power and frequency).

In some embodiments, the electronic device includes a processor that is in data communication with a hardware storage device and a communication device. The communication device is in electrical communication with and/or includes an antenna element.

In some embodiments, the hardware storage device(s) is a non-transient storage device including any of RAM, ROM, EEPROM, magnetic disk storage or other magnetic storage devices, or any other medium which can be used to store desired program code means in the form of computer-executable instructions or data structures and which can be accessed by a general purpose or special purpose processor, such as the processor. In some embodiments, the hardware storage device has instructions stored thereon that, when executed by the processor, cause the electronic device to perform any parts of any of the methods described herein.

In some embodiments, the communication device(s) is in data communication with the processor(s) to allow communication with one or more external computing devices, networks, or components. In some embodiments, the communication device is a network communications device, such as Wi-Fi or cellular. In some embodiments, the communication device is a short-range wireless communication, such as a BLUETOOTH connection or a Wi-Fi-Direct connection, which allows data communication between the electronic device and other electronic devices in proximity to the electronic device without connection to a network adapter or access point.

In some embodiments, an electronic device includes a plurality of antenna elements. For example, each of the antenna elements may be in electrical communication with a different communication device. In other examples, at least two antenna elements of the plurality of antenna elements are in electrical communication with a single communication device. In at least one embodiment, an electronic device includes three antenna elements. The three antenna elements may be used for different purposes depending on the position of the antenna elements on the body and/or temple(s) (and the associated relationship to the user's head).

For example, a first antenna element is positioned at a distal end of the temple away from the body. The position of the first antenna element allows the first antenna element to receive an incoming RF transmission with comparatively less interference from other electronic components that are located in the body of the electronic device. However, the position of the first antenna element may cause outgoing RF transmission from the first antenna element to expose the user's head to greater RF radiation and causes more signal attenuation from the user's head than another antenna element positioned elsewhere on the electronic device. A second antenna element may be positioned on/in the temple, and a third antenna element may be positioned on/in the body. For example, a first antenna element may be positioned in one temple and a second antenna element may be positioned in another temple. In another example, a first antenna element may be positioned in a proximate portion of a temple (e.g., closer to the body) and a second antenna element may be positioned in a distal portion of the temple (e.g., further from the body).

The antenna elements on the temple(s) may be diversity antennas, which are primarily used for receiving RF transmissions, while the third antenna element positioned in/on the body may be the primary antenna for transmissions, allowing the electronic device to transmit at a higher transmission power.

In some embodiments, the antenna elements are the same and can receive or transmit at the same frequencies. In some embodiments, at least one of the antenna elements is different from another and can receive or transmit at different frequencies. For example, the first antenna may be a diversity antenna that operates in the cellular ranges between 600 MHz and 3.7 GHz and in the global positioning system (GPS) range at approximately 1.6 GHz. The second antenna may be a diversity antenna that operates in the Wi-Fi ranges at approximately 2.4 GHz and above 5.0 GHz. The third antenna may be a primary antenna that operates in both the cellular and Wi-Fi ranges.

The antenna element in the body of the electronic device may be placed in different locations and/or have different configurations. For example, an embodiment of an electronic device has a first antenna element on a first side of the body (e.g., proximate a first lens) and a second antenna element on a second side of the body (e.g., proximate a second lens). In some embodiments, the housing or outer surface of a portion of the body is conductive and the conductive material of the body is part of the antenna element. In other embodiments, the conductive material of the antenna element is positioned inside a nonconductive (e.g., plastic) housing of the body. A conductive material of the body can be used for the antenna element to reduce mass and size of the body of the electronic device. In some embodiments, the first antenna element is a loop antenna, and the second antenna element is a monopole antenna. In some embodiments, the first antenna element and second antenna element are the same type of antenna element, such as both being a loop antenna or both being a monopole antenna. In some embodiments, the electronic device has only one antenna element on/in the body, and in some embodiments, the electronic device has more than two antenna elements on/in the body.

A loop antenna is an RF antenna that may be used for transmitting and/or receiving RF transmissions. The loop antenna consists of a loop of conductive material such as a wire or strip of metal. The spectrum of usable frequencies for a loop antenna is based at least partially on a perimeter length of the loop. In some embodiments, the first antenna element of the electronic device is a loop antenna element that includes a frame split proximate an antenna feed. The antenna feed feeds the first antenna element, which is connected to a ground element of the body. In some embodiments, the effective antenna length of a loop antenna, such as the first antenna element, is the length from the frame split to the ground element. In some embodiments, the ground element is positioned in an upper rim of the body. In some embodiments, the upper rim is coupled to the temple(s) by a hinge. In some embodiments, the upper rim is coupled to the temple(s) by a flexible connection. In some embodiments, the upper rim is coupled to the temple(s) by a rigid connection.

A monopole antenna is an RF antenna that may be used for transmitting and/or receiving RF transmissions. The monopole antenna consists of a conductor, often mounted over a conductive surface. The driving signal from the transmitter is applied, or for receiving antennas the output signal to the receiver is taken, between the monopole and the ground plane. In some embodiments, the second antenna element is a monopole antenna positioned between frame splits in the lower rim and/or lateral side of the body. In some embodiments, the second antenna element is a monopole antenna positioned between frame splits in the lower rim and/or lateral side of the body and not in the upper rim of the body. In some embodiments, an antenna feed is positioned proximate a frame split. In some embodiments, the effective antenna length of a monopole antenna, such as the second antenna element, is the length of the conductive material (e.g., the second antenna element) between the two frame splits.

In some embodiments, the effective antenna length of antenna elements of an electronic device is at least partially based on the desired frequencies used by the electronic device. In some embodiments, the effective antenna length is at least ½ of the minimum wavelength for loop antenna. For example, an antenna used to transmit or receive 5.0 GHz Wi-Fi signals may have an effective antenna length of at least 30 mm. In another example, an antenna used to transmit or receive 1000 MHz low band cellular signals may have an effective antenna length of at least 15 cm.

In some embodiments, the effective antenna length is at least ¼ of the minimum wavelength for monopole antenna. For example, an antenna used to transmit or receive 5.0 GHz Wi-Fi signals may have an effective antenna length of at least 15 mm. In another example, an antenna used to transmit or receive 1000 MHz low band cellular signals may have an effective antenna length of at least 7.5 cm.

In some embodiments, the loop antenna and the monopole antenna are used in conjunction with one another. In some embodiments, the loop antenna and the monopole antenna are used with additional patch antennas in the electronic device. For example, the electronic device may receive transmissions with an antenna in a first location in the electronic device and transmit transmissions with a different antenna at a second location in the electronic device to limit the SAR experienced by the user. When the antenna is positioned in the body (such as a lower rim or a lateral side of the body), a higher transmission power may be used.

In some embodiments, a method of wireless communications in an HMD includes providing an HMD configured to be worn on a user's head. The HMD includes a first RF antenna positioned in or on a body of the HMD and a second RF antenna positioned in a temple of the HMD. As described herein, the first RF antenna in the body may be positioned in the lower rim of the body, in the lateral side(s) of the body, or both. The method further includes receiving an incoming transmission with the second antenna. After receiving the incoming transmission with the second antenna, the method includes transmitting an outgoing transmission with the first antenna in response to the incoming transmission. In some embodiments, the incoming transmission and the outgoing transmission have the same frequency. In some embodiments, the incoming transmission and the outgoing transmission have a different frequency.

In at least one embodiment, an electronic device and/or method of using an electronic device according to the present disclosure allows an HMD to transmit RF signals with a greater transmission power and/or lower SAR for the user than a conventional HMD. In at least one example, a front frame antenna can transmit at least 4 times more power compared to the temple antenna at the same absorption level.

The present disclosure relates to systems and methods for wireless communication in an HMD according to at least the examples provided in the sections below:

[A1] In some embodiments, an electronic device has a frame configured to be worn on a user's head, where the frame includes a body and a temple coupled to the body. The body is configured to support a lens. The electronic device includes a processor in the frame and an RF antenna positioned in the body and in data communication with the processor.

[A2] In some embodiments, the RF antenna of [A1] is a patch antenna.

[A3] In some embodiments, the RF antenna of [A1] is a loop antenna.

[A4] In some embodiments, the RF antenna of [A1] is a monopole antenna.

[A5] In some embodiments, the RF antenna of any of [A1] through [A4] includes an antenna element located in a lower rim of the body

[A6] In some embodiments, the RF antenna of any of [A1] through [A4] includes an antenna element located in a lateral side of the body and not in a lower rim of the body.

[A7] In some embodiments, the RF antenna of any of [A1] through [A6] includes a ground element in an upper rim of the body and the upper rim of the body is coupled to the temple by a hinge.

[A8] In some embodiments, the RF antenna of any of [A1] through [A7] is a first RF antenna, and the electronic device further includes a second RF antenna in the body of the frame.

[A9] In some embodiments, the first RF antenna of [A8] is a cellular antenna, and the second RF antenna of [A8] is a Wi-Fi antenna.

[A10] In some embodiments, the first RF antenna of [A8] is a loop antenna, and the second RF antenna of [A8] is a monopole antenna.

[A11] In some embodiments, the RF antenna of any of [A1] through [A10] includes an antenna element with an effective antenna length of at least 15 millimeters.

[A12] In some embodiments, the effective antenna length of [A11] is at least 7.5 centimeters.

[B1] In some embodiments, an electronic device includes a frame configured to be worn on a user's head where the frame includes a body configured to support a lens, a first temple coupled to the body, and a second temple coupled to the body. The electronic device further includes a processor in the frame, a first RF antenna positioned in the body and in data communication with the processor, and a second RF antenna positioned in the first temple or second temple and in data communication with the processor.

[B2] In some embodiments, the second RF antenna of [B1] is a diversity antenna.

[B3] In some embodiments, the second RF antenna of [B1] is a cellular antenna.

[B4] In some embodiments, the electronic device of any of [B1] through [B3] includes a third RF antenna positioned in the first temple or second temple and in data communication with the processor.

[B5] In some embodiments, the first RF antenna of [B4] is a primary transmission antenna, the second RF antenna is a diversity cellular antenna, and the third RF antenna is a diversity Wi-Fi antenna.

[C1] In some embodiments, a method of communicating data in an HMD includes providing an HMD configured to be worn on a user's head, where the HMD includes a first RF antenna positioned in a body of the HMD and a second RF antenna positioned in a temple of the HMD, receiving an incoming transmission with the second antenna, and transmitting an outgoing transmission with the first antenna.

[C2] In some embodiments, the incoming transmission and the outgoing transmission of [C1] have the same frequency.

[C3] In some embodiments, the first antenna of [C1 or [C2] transmits the outgoing transmission with a transmission power of at least 100 mW.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about”, “substantially”, or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. An electronic device comprising:
a frame configured to be worn on a user's head, the frame including:
a body configured to support a lens, and
a temple coupled to the body;
a processor in the frame; and
a radio frequency (RF) antenna positioned in the body and in data communication with the processor, where an antenna element of the RF antenna is not in an upper rim of the body.

2. The electronic device of claim 1, wherein the RF antenna is a patch antenna.

3. The electronic device of claim 1, wherein the RF antenna is a loop antenna.

4. The electronic device of claim 1, wherein the RF antenna is a monopole antenna.

5. The electronic device of claim 1, wherein at least part of the antenna element is located in a lower rim of the body.

6. The electronic device of claim 1, wherein at least part of the antenna element is located in a lateral side of the body and not in a lower rim of the body.

7. The electronic device of claim 1, wherein the RF antenna includes a ground element in the upper rim of the body, the upper rim of the body being coupled to the temple by a hinge.

8. The electronic device of claim 1, wherein the RF antenna is a first RF antenna, and the electronic device further includes a second RF antenna in the body of the frame.

9. The electronic device of claim 8, wherein the first RF antenna is a cellular antenna, and the second RF antenna is a Wi-Fi antenna.

10. The electronic device of claim 8, wherein the first RF antenna is a loop antenna, and the second RF antenna is a monopole antenna.

11. The electronic device of claim 1, wherein the RF antenna includes an antenna element with an effective antenna length of at least 15 millimeters.

12. The electronic device of claim 11, wherein the effective antenna length is at least 7 centimeters.

13. An electronic device comprising:
a frame configured to be worn on a user's head, the frame including:
a body configured to support a lens,
a first temple coupled to the body, and
a second temple coupled to the body;
a processor in the frame;
a first radio frequency (RF) antenna positioned in the body and in data communication with the processor, where an antenna element of the first RF antenna is not in an upper rim of the body; and
a second RF antenna positioned in the first temple or second temple and in data communication with the processor.

14. The electronic device of claim 13, wherein the second RF antenna is a diversity antenna.

15. The electronic device of claim 13, wherein the second RF antenna is a cellular antenna.

16. The electronic device of claim 13, further comprising a third RF antenna positioned in the first temple or second temple and in data communication with the processor.

17. The electronic device of claim 16, wherein the first RF antenna is a primary transmission antenna, the second RF antenna is a diversity cellular antenna, and the third RF antenna is a diversity Wi-Fi antenna.

18. A method of communicating data in a head-mounted device (HMD), the method comprising:
providing an HMD configured to be worn on a user's head, the HMD including:
a first RF antenna positioned in a body of the HMD, and
a second RF antenna positioned in a temple of the HMD;
receiving an incoming transmission with the second antenna; and
in response to receiving the incoming transmission with the second antenna, transmitting an outgoing transmission with the first antenna.

19. The method of claim 18, wherein the incoming transmission and the outgoing transmission have the same frequency.

20. The method of claim 19, wherein the first antenna transmits the outgoing transmission with a transmission power of at least 100 milliwatts.
